(19) United States
(12) Patent Application Publication
(10) Pub. No.: US 2014/0199507 A1
(43) Pub. Date: Jul. 17, 2014

(54) Animal and human related products and methods of manufacturing such

(71) Applicant: Holly Marie Moran, Vienna, VA (US)

(72) Inventor: Holly Marie Moran, Vienna, VA (US)

(21) Appl. No.: 13/694,903

(22) Filed: Jan. 17, 2013

(51) Int. Cl. B32B 1/06; A47G 9/10; A01K 1/015; A47G 9/00; B31D 5/00; A01K 29/00

(52) U.S. Cl. CPC B32B 1/06; B31D 5/00; A01K 29/00; A01K 1/0157; A47G 9/00; A47G 9/10
USPC 428/35.6; 428/34.1; 428/36.8; 428/36.1; 428/35.7; 446/268; 493/394; 119/707; 119/28.5; 5/482; 5/636

(57) ABSTRACT

A stuffed article, for example a toy, flying disk, bed, or etc., and manufacturing methods of such are disclosed which has volume and which upon destruction by an animal will not release stuffing as with most common stuffed toys, flying disks, or beds. The article is made from at least one material such as fabric, canvas, denim, nylon, fleece, rubber, plastic, leather, rawhide, animal parts, fiber (or other pliable material) which, through the article's configuration and manufacturing process is filled with the same type of material used to form the outer layers, multiple layers may be used for increased strength, and specifically the inner cavity contains material which is one and the same type of material as the outer layer(s).

This application expressly claims priority to Provisional Application No. 61/632,627 entitled “Animal and Human Related Products and Methods of Manufacturing Such”, which is incorporated herein by reference.

### FIELD OF THE INVENTION

This invention relates to the field of items for animals particularly for amusement and for bedding purposes and for human related products, and specifically to a way of creating and manufacturing a soft type of article of manufacture that can be used as an animal toy, flying disk, or bed, children's toys, human bedding and pillows, furniture, environmental products such as absorbent pads and booms, etc., where a durable, appealing, flexible and soft item is needed.

### BACKGROUND OF THE INVENTION

Many domestic pets, such as dogs and cats, enjoy playing with toys by chewing, scratching, pulling and pushing them or moving them around with their nose, teeth and front legs, or hind legs for cats. This behavior is natural to animals and keeps the animals active while assisting in the development of their motor coordination. Also, playing with such toys provides pets with an outlet for these natural instincts, helps prevent boredom, and is psychologically rewarding. When such toys are not available for the animal, the animal may exercise these natural tendencies on any available items. Uncontrolled “play” may therefore result in damage to items surrounding the pet. For example, domestic pets can damage furniture, carpeting, walls, and shoes. Most pets also enjoy having a soft bed or small pad to lie on and sleep. Often this bedding material becomes ripped or torn in much the same way toys can become damaged. Many pets seem to take possession of their toys and bedding and gain comfort from having them around. A toy or bed that can be easily cleaned is more desirable. A toy or bed with a longer life span is also more appealing.

In addition to providing exercise for a pet and an outlet for the animal's natural tendencies for chewing, scratching, etc., toys may often play an important role in the interaction between an owner and pet. For example, an owner and pet may engage in a game of fetch, tug-of-war, and the like. Interactive play of this type has been found useful for developing a positive relationship between an owner and pet. Animal toys and beds that are easily washable in a standard washing machine and dryer are also more desirable to the pet owner.

Some examples of the chew and play toys available for animals are rawhide chews or bones, cloth pulls and ropes, as well as various vinyl, plastic, rubber and latex toys. In such category of alternatives, fabric or stuffed animal toys are often one toy variety of choice for interactive play between an owner and pet. Fabric and stuffed toys are also soft and typically appealing to both the pet and consumer.

Some examples of beds available for animals are made from foam or stuffing filled fabric. Beds of this type are not very durable. Some other types of more durable animal beds are constructed of hard plastic or a plastic and canvas combination.

Unfortunately, fabric or stuffed animal toys or beds often have a downside, amongst which is a relatively short life span. One reason is that chewing or scratching of such products tends to rupture the fabric allowing the animal to remove the stuffing and destroy any useful life. Many toys designed for pets are carried in the jaws of the animal, tossed, chewed and trampled. Similarly, tugging or pulling on the stuffed toy tends to puncture or rip the fabric. In either circumstance, the stuffed toy rapidly deteriorates, loosing its stuffing, or the toy is ripped into many pieces. Many animals focus their efforts on removing the stuffing from the toy and either spread the stuffing around or, worse, may ingest the stuffing possibly resulting in endangering the animal's health. Health concerns from stuffing may include passing of the stuffing or a blocked intestinal tract requiring medical attention. Indeed, these modes of toy failure are the common result of everyday play, not to mention the fact that especially vigorous play accelerates such destruction resulting in an even shorter toy life span. Additionally, soft fabric beds are often very attractive to the animal owner; however if the animal is left unsupervised for long periods of time, perhaps while the owner is at work, the animal may destroy the bed. This is especially common in instances where dogs are kept in a crate or confined in a small area and often the bed is the only object within reach of the animal and therefore will be destroyed.

Making a more durable toy or bed can result in a “hard feel” and loses its appeal to the animal. Most animals prefer soft manageable toys that have some “give” and that can be easily manipulated and provide exercise for the jaw. Pet owners also benefit from soft toys for indoor play resulting in less damage if an object is thrown indoors. Many animals prefer soft bedding to sleep on over hard surfaces and many pet owners provide a pad or mattress for use exclusively by their pet.

To solve the problem of short-lived amusement articles, certain toy or bed manufactures have reinforced the outer layers and seams of stuffed toys or beds making them rigid and unappealing. To solve the problem of stuffing being removed from toys or beds and being ingested or strewn about, some toys are being made with no stuffing resulting in an unappealing, limp shell of a toy that very closely resembles the remains of a used or destroyed stuffed toy.

Accordingly, there is a need for an article which provides a soft, three dimensional, strong, deformable, durable, and attractive pet toy or soft, strong, durable, and comfortable bed that an animal can sink its teeth into, cuddle with and feel emotionally comforted by the invention and has a longer lifespan for the pet owner.

### SUMMARY OF THE INVENTION

It is an object of an embodiment of the invention to provide a soft, three dimensional, strong, deformable, durable, and attractive pet toy or soft, strong, durable, and comfortable bed that an animal can sink its teeth into, cuddle with and feel emotionally comforted by the invention and has a longer lifespan for the pet owner.

It is another object of an embodiment of the invention to provide an article, for example a toy, flying disk, bed, or etc., which has volume and which upon destruction by an animal will not release stuffing as with most common stuffed toys, flying disks, or beds. The article is made from at least one material such as fabric, canvas, denim, nylon, fleece, rubber, plastic, leather, rawhide, animal parts, fiber (or other pliable material) which, through the article's configuration and manufacturing process is filled with the same type of material used to form the outer layers, multiple layers may be used for increased strength, and specifically the inner cavity contains material which is one and the same type of material as the outer layer(s). According to an embodiment of the invention, the article can be manufactured in multiple ways. One method uses a continuous piece of fabric to form both the outer layer and the filling, and whose inner cavity contains continuous fabric, and specifically gives the article volume and mass without using a different or separate piece of material from the outer layer(s) for the contents of the inner cavity. This type of manufacturing makes removal of the inner cavity's contents by the animal difficult. Another method of manufacturing is to insert pieces of the same material used to form the outer layers into the inner cavity filling the inner cavity and giving the article volume. Either of the manufacturing methods yields an article whose inner cavity is filled with the same material as the outer layer(s) giving the article one common smell and texture, thereby making discovery and removal of the inner filling from the article by the animal less desirable than as is seen with most common stuffed animal toys or beds.

It is another object of an embodiment of the invention to provide an article, for example, a toy, flying disk, bed, or etc., that is easily compressed in the mouth of an animal or under its paws and has the feeling of being “stuffed”, and whose outer layers and filling are made from the same type of material. The article may also contain additional items such as: squeakers, noise makers, aromatic objects, cat nip, cedar wood chips or other auditory, tactile, scented, attractive items, or etc.

It is another object of an embodiment of the invention to provide an article, for example, a toy, flying disk, bed, or etc., that may have protruding fringe, at least one tab, rope, string, at least one handle or other items on zero, one, or more sides, and encompassing none, a portion of, or the entire perimeter of the object.

It is another object of an embodiment of the invention to provide an article, for example, a toy, flying disk, bed or, etc., that is attractive looking. A variety of different colorful patterns may be applied to the fabric, multiple color combinations of fabric, embroidery, fabric of varying textures, or other adornments may be used. Any and/or all combinations of these items may be used to increase the attractiveness of the article.

It is another object of an embodiment of the invention to provide an article that if constructed from common fabrics the article may be easily cleaned in a standard household washing machine and dryer.

Still another object of an embodiment of the invention is to provide methods for advantageously manufacturing such an article, for example, a toy, flying disk, bed, or etc., and that the article can also be manufactured relatively easily and inexpensively. Multiple methods of manufacturing the present invention with variations and modifications are presented here. Any of these methods of manufacturing and variations or modifications may be used independently or combined to create a variety of different variations of the article and increase attractiveness.

According to one embodiment of the invention, a stuffed article is disclosed comprising: a single piece of material having a first part and a second part, wherein the first part of the single piece of material forms an outer cover of the stuffed article, wherein the second part of the single piece of material is positioned in an inner cavity inside the outer cover to form the stuffing of the stuffed article; and binding along at least a portion of a perimeter of the outer cover to hold the stuffed article together.

According to another embodiment of the invention, a stuffed article is disclosed comprising: a first piece of material having a first section and a second section wherein the first section of the first piece of material forms part of an outer cover of the stuffed article; a second piece of material having a first section and a second section wherein the first section of the second piece of material forms part of the outer cover of the stuffed article, wherein the second sections of the first and second pieces of material are positioned in an inner cavity inside the outer cover to form the stuffing of the stuffed article; binding along at least a portion of a perimeter of the outer cover for binding together portions of the first sections of the first and second pieces of material to hold the stuffed article together.

According to another embodiment of the invention, a method for manufacturing a stuffed article is disclosed comprising the steps of: folding a single piece of material so as to create overlapping upper and lower layers of material; binding together a portion of the upper and lower layers wherein the binding is performed inside a perimeter of the overlapping upper and lower layers of material, wherein a gap is left in the binding, wherein the binding creates an inner area inside the binding and an outer area outside the binding; pulling the entire piece of material through the gap in the binding thereby turning the folded piece of material inside out and creating the stuffed article, wherein the material in the inner area creates an outer covering of the stuffed article and the material in the outer area creates the stuffing of the stuffed article in an inner cavity inside the outer cover; and binding the gap together to close the outer covering.

According to another embodiment of the invention, a method for manufacturing a stuffed article is disclosed comprising the steps of: folding a first piece of material into a desired shape; folding a second piece of material into the desired shape; binding said first and second pieces of material thereby creating the stuffed article, wherein first sections of the first and second pieces of material form an outer cover and second sections of the first and second pieces of material form stuffing for the stuffed article.

According to another embodiment of the invention, a method for manufacturing a stuffed article is disclosed comprising the steps of: placing a first piece of material over a second piece of material so that the first and second pieces of material at least partially overlap; binding together a portion of the first and second pieces of material wherein the binding is performed inside a perimeter of the overlapping materials, wherein a gap is left in the binding, wherein the binding creates an inner area inside the binding and an outer area outside the binding; pulling the first and second pieces of material through the gap in the binding thereby turning the bound pieces of materials inside out and creating the stuffed article, wherein the material in the inner area creates an outer covering of the stuffed article and the material in the outer area creates the stuffing of the stuffed article in an inner cavity inside the outer cover; and binding the gap together to close the outer covering.

According to another embodiment of the invention, a method for manufacturing a stuffed article is disclosed comprising the steps of: folding a single continuous piece of material into a desired shape; and binding together at least a portion of a perimeter of the folded single continuous piece of material thereby creating the stuffed article with an outer cover and an inner stuffing, wherein the outer cover of the stuffed article is formed from a first section of the single continuous piece of material and the inner stuffing is formed from a second section of the single continuous piece of material.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 depicts a perspective, cut away, cross sectional view of an article such as a finished toy or bed in the general shape of a rectangle with an optional tab adornment on one side of the toy according to one embodiment of the invention;

FIG. 2 depicts a perspective, cut away, cross sectional view of a finished flying disk or bed in the general shape of an oval according to one embodiment of the invention;

FIGS. 3A-3L depicts steps for the first method for manufacturing an article with two outer layers and a protruding tab similar to the article in FIG. 1 according to one embodiment of the invention;

FIGS. 4A-4G depicts steps for a second method for manufacturing an article with one outer layer according to one embodiment of the invention;

FIGS. 5A-5G depicts steps for a third method for manufacturing an article with one outer layer and a protruding tab according to one embodiment of the invention;

FIGS. 6A-6D depicts a modification or variation to the invention and shows the manufacturing of a one layered article with an internal pocket which once the article is finished will be enclosed within the outer layers of the article according to one embodiment of the invention;

FIG. 7 depicts a modification or variation to the invention for increased attractiveness and shows an article in the shape of a triangle and having six fabric tabs according to one embodiment of the invention;

FIG. 8 depicts a modification or variation to the invention for increased attractiveness and shows an article in the shape of a circle having fringe around the perimeter of the article according to one embodiment of the invention;

FIG. 9 depicts a modification or variation to the invention and shows an article in the shape of a rectangle having a rope “pull” protruding from the article according to one embodiment of the invention;

FIG. 10 depicts the first steps in the manufacturing process where the size of the article is determined and any tabs or protrusions are made ready according to one embodiment of the invention;

FIG. 11 continues from FIG. 10 and depicts the next steps in the manufacturing process when the Inside Out Manufacturing method is used according to one embodiment of the invention;

FIG. 12 continues from FIG. 10 and depicts the next steps in the manufacturing process when the Right Side Out Manufacturing method is used according to one embodiment of the invention; and

FIGS. 13A-13I depicts steps for a fourth method for manufacturing an article with one outer layer made from a single continuous piece of fabric with visible edge stitching according to one embodiment of the invention.

### DETAILED DESCRIPTION OF PREFERRED EMBODIMENTS OF THE INVENTION

As will be described in detail below, the present invention relates to an article of manufacture 20, 20′, 20″, 20′″ and the methods for making the article, wherein the article is an animal toy, flying disk, bed, children's toy, human bedding and pillows, furniture, environmental products such as absorbent pads and booms, etc., and the invention is not limited thereto.

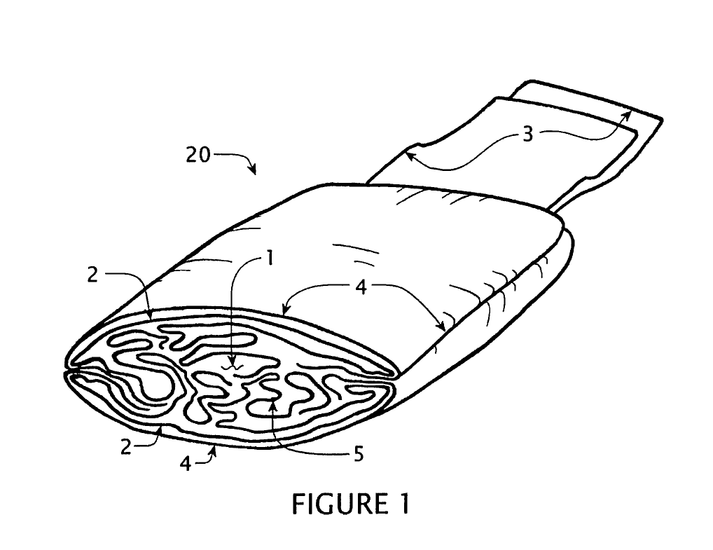

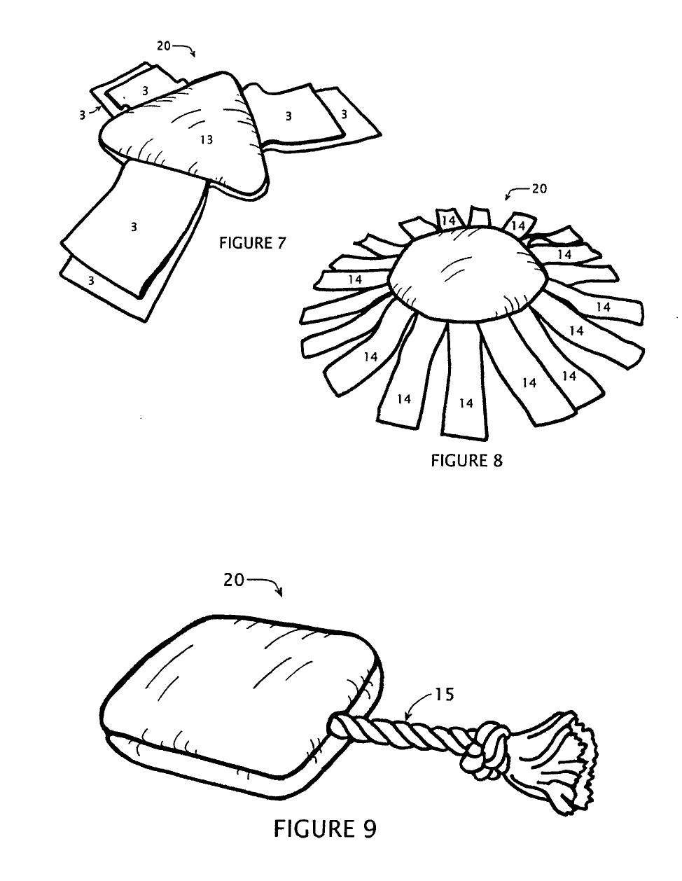

It is to be appreciated that while the article 20 is illustrated having the configuration of a rectangle in FIG. 1, and an oval shape in FIG. 2, the present invention is not limited thereto. For example, the article 20 may be configured as virtually any shape comprising: a square, rectangle, triangle (FIG. 7), oval (FIG. 2) and (FIG. 8), dog bone silhouette, heart, animate or inanimate object and the like and the invention is not limited thereto. The article may contain items or have protrusions used to increase attractiveness. For increased durability the article may have multiple outer layers, and is easy to wash and manufacture.

While the following descriptions and examples of construction of a stuffed article will refer to the article being constructed out of fabric, it will be understood by those skilled in the art that all of the articles can be constructed out of one or more materials, such as, fabric, canvas, denim, nylon, fleece, rubber, plastic, leather, rawhide, animal parts, fiber, etc., and the invention is not limited thereto.

The durable, soft article is preferably fabricated with an exterior layer of fabric, fleece, or a flexible or soft covering. The article may be constructed from a unitary piece of covering or may be fabricated from multiple pieces and the invention is not limited thereto. The article is soft and comfortable, has the feeling of being “stuffed” and does not contain a different type of stuffing material. While the article is being manufactured in ways to reduce the amount of “stuffing” an animal/pet might remove, detach and/or ingest if the outer cover is torn or penetrated, all worn or damaged articles should be immediately discarded. In addition, do not leave the article unattended with animals/pets, and particularly those animals/pets that tend to eat their toys.

According to one embodiment of the invention, the article will provide, for example, a soft, strong, deformable, durable and attractive pet toy or soft, strong, durable, and comfortable bed that an animal can sink its teeth into, cuddle with and feel emotionally comforted by the article and has a longer lifespan for the pet owner but the invention is not limited thereto.

The article is soft, three dimensional, has increased durability, and is an object having volume, wherein upon destruction by an animal, will not release stuffing, as with most common stuffed toys, flying disks or beds. The article is made from one or more sheets or layers of fabric (or other pliable material) which, through the article's configuration and manufacturing process is filled with the same type of material used to form the outer layers, multiple layers may be used for increased strength, and specifically the inner cavity contains material which is one and the same type of material as the outer layer(s). As will be described below in detail, the article can be manufactured in multiple ways. One method uses a continuous piece of fabric to form both the outer layer and the filling, and whose inner cavity contains continuous fabric, and specifically gives the article volume and mass without using a different or separate piece of material from the outer layer(s) for the contents of the inner cavity. This type of manufacturing makes removal of the inner cavity's contents by the animal difficult. Another method of manufacturing is to insert pieces of the same material used to form the outer layers into the inner cavity filling the inner cavity and giving the article volume. Either of the manufacturing methods yields an invention whose inner cavity is filled with the same material as the outer layer(s) giving the invention one common smell and texture thereby making discovery and removal of the inner filling from the article by the animal less desirable than as is seen with most common stuffed animal toys or beds.

The article can have increased strength by using multiple outer layers or by using one or more materials, such as, fabric, canvas, fleece, denim, nylon, leather, rawhide, animal parts, fiber or other depending on the desired strength or softness and the invention is not limited thereto.

The article is easily compressed in the mouth of an animal or under its paws and has an inner cavity which in addition to fabric may contain one or more additional items such as: squeakers, noise makers, aromatic objects, cat nip, cedar wood chips, or other auditory, tactile, scented, attractive items, etc., and the invention is not limited thereto.

The article can have protruding fringe, at least one tab, string, at least one handle, rope, or other items on zero, one, or more sides, and encompassing none, a portion of, or the entire perimeter or surface of the object. According to one embodiment of the invention, such protrusions may also be of a size and shape that, in addition to protruding on the outside of the finished article, may also be large enough that the end of the protrusion on the inside of the finished article may account for some or substantially all of the stuffing 5 in the inner cavity 1. Additionally, to make the toy, flying disk, or bed attractive looking, a variety of different materials, colorful patterns, color combinations, embroidery, or fabric of varying textures, may be used, or applied to the fabric, multiple combinations of these or other adornments may be used and the invention is not limited thereto.

The article may be constructed using any and/or all combinations of modifications or variations to increase the attractiveness of the article and the invention is not limited thereto.

If constructed from common fabrics, the article may be easily cleaned in a standard household washing machine and dryer.

The article can be manufactured relatively easily and inexpensively as set forth in the various methods described below. It is to be understood that not all methods for manufacturing are included here and those described here are for illustrative purposes. Other methods of manufacturing that result in an article that has an outer layer and a filling consisting of the same material are also considered to be covered by embodiments of this invention as will be understood by one of ordinary skill in the art based on the information below.

The article may be manufactured by using thread and sewing, glue, heat welded, melted, zippers, hook and loop material (Velcro®), snaps, spring clips or any other means suitable to bind the material used to construct the article. The sewing of the article may be in a straight line stitch, zigzag, or other type of stitching, and may consist of one line of stitches or multiple rows of stitches (running parallel, perpendicular, or other) to increase the strength of the seams, filling, outer layers, or the attractiveness of the invention and the invention is not limited thereto. Additionally, bias tape, fabric piping, ribbon, or other fancy stitching or adornments may be added to the article on the seams or located elsewhere on or inside the article to increase the attractiveness and the invention is not limited thereto.

FIG. 1 depicts a cut away, cross sectional view of a finished, multidimensional article 20, for example, a toy or bed, possessing volume and possibly adornments such as a tab 3. The article 20 depicted here is manufactured by first sewing the fabric layers together and then turning the article 20 right side out thereby concealing the stitching inside the article 20. The inner cavity 1 of the article 20 is filled with a continuous portion of the covering material or fabric 2 and is comprised of a continuous volume of material 5 not separated or disconnected from the covering 2. Specifically, the filling material 5 gives the article 20 an appealing full and stuffed appearance similar to a stuffed toy, however the article 20 will not contain any loose stuffing in the traditional sense. Specifically, the covering 2 is cut to be of a specific size to provide volume to the inner cavity 1 to the desired size or mass for the article 20. The inner cavity 1 of the article 20 may also contain squeakers, noise makers, aromatic objects, cat nip, cedar wood chips or other auditory, tactile, attractive items, and the article 20 may have protruding tab(s) 3, fringe, rope, or other items on zero, one, or more sides, and encompassing none, a portion of, or the entire perimeter of the article 20 and the invention is not limited thereto. In an alternative embodiment of the invention, the tab 3 can be of sufficient size and shape to become some or substantially all of the stuffing 5 if the tab is left on the inside of the article 20.

Also, to give the article 20 an attractive appearance a variety of different colorful patterns may be applied to the outer fabric, and/or multiple color combinations of fabric used in the construction of the article 20. Depending on the needed durability, the construction of the article 20 may have one or more layers of outer fabric 4 or be constructed from a material which will increase the strength of the article 20 or may provide tactile stimulation and the invention is not limited thereto. Additionally, the rectangular shape depicted in FIG. 1 may be manufactured in any size up to and including sizes large enough for use as a bed for an animal. For illustrative purposes two outer layers are depicted in FIG. 1 and FIG. 2, but the number of outer layers may be one or more.

Embroidery, fabric of varying textures, or other adornments may be used. Additionally, the amount of filling 5 contained in the inner cavity 1 may be varied to yield different densities of volume making the article 20 light, fluffy, and pliable, or fuller, and firm. While the article 20 is being manufactured in ways to reduce the amount of “stuffing” an animal/pet might remove, detach and/or ingest if the outer cover is torn or penetrated, all worn or damaged articles should be immediately discarded. In addition, do not leave the article 20 unattended with animals/pets, and particularly those animals/pets that tend to eat their toys.

FIG. 2 depicts a cut away, cross sectional view of a finished, multidimensional article 20, for example, a toy or bed possessing volume, with such volume's location and size specifically being positioned as to provide a shape having a variable cross sectional area. The article 20 depicted in FIG. 2 is manufactured by first sewing the layers 2 & 4 together and then turning the article 20 right side out thereby concealing the sewing inside the article 20. The inner cavity 1 is filled with a continuous portion of the covering 2 and is comprised of a continuous volume of filling 5 not separated or disconnected from the covering 2. A cross section of varying size may be advantageous for such types of toys as a flying disk, or other, and when the article 20 is constructed with the appropriate dimensions the article 20 may be used for a bed, crate liner, or other device, providing a soft comfortable pad 6 with a rolled edge 7 for the animal and the invention is not limited thereto. Additionally, the amount of filling 5 contained in the inner cavity 1 may be varied to yield different densities of volume making the article 20 light, fluffy, pliable, fuller, or firm. Depending on the needed durability, the construction of the article 20 may have one or more layers of outer fabric 4 or be constructed from a material which will increase the strength of the article 20 or may provide tactile stimulation.

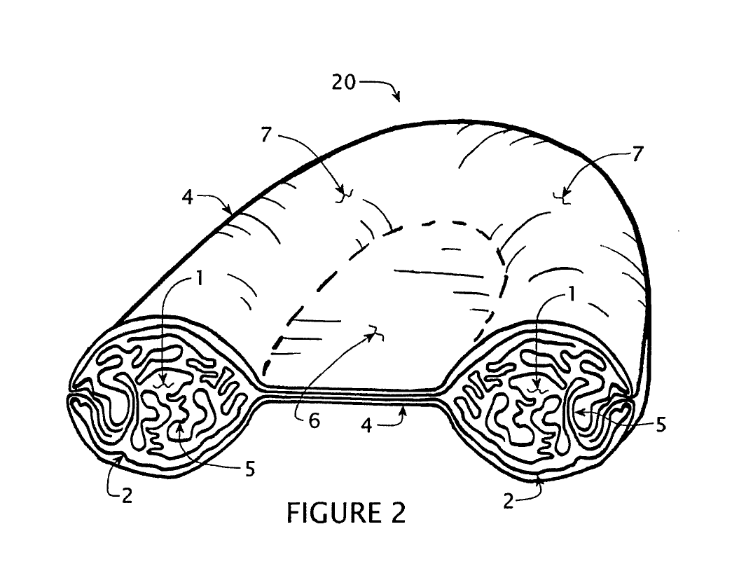

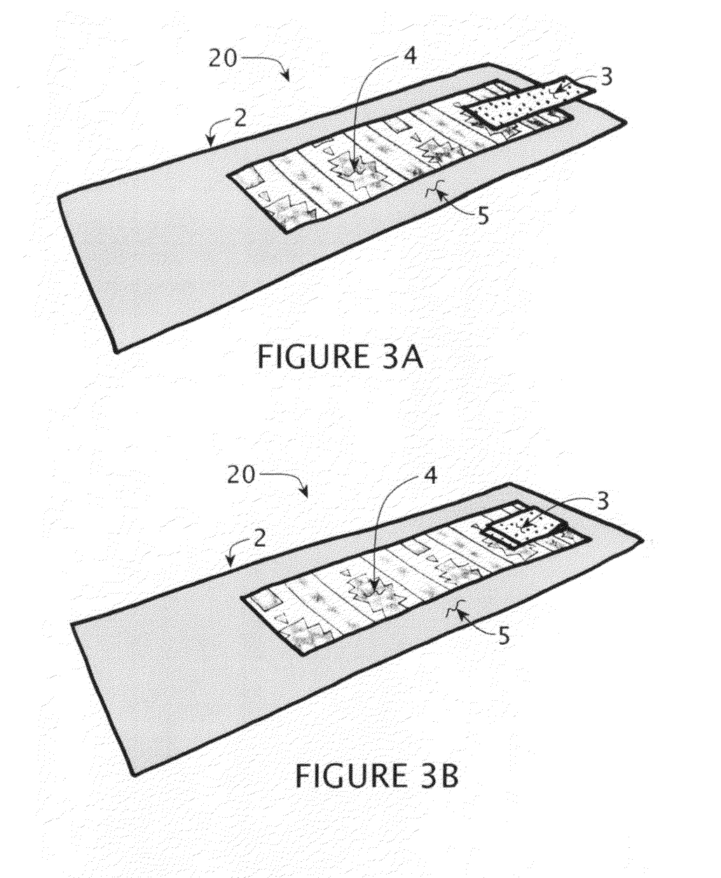

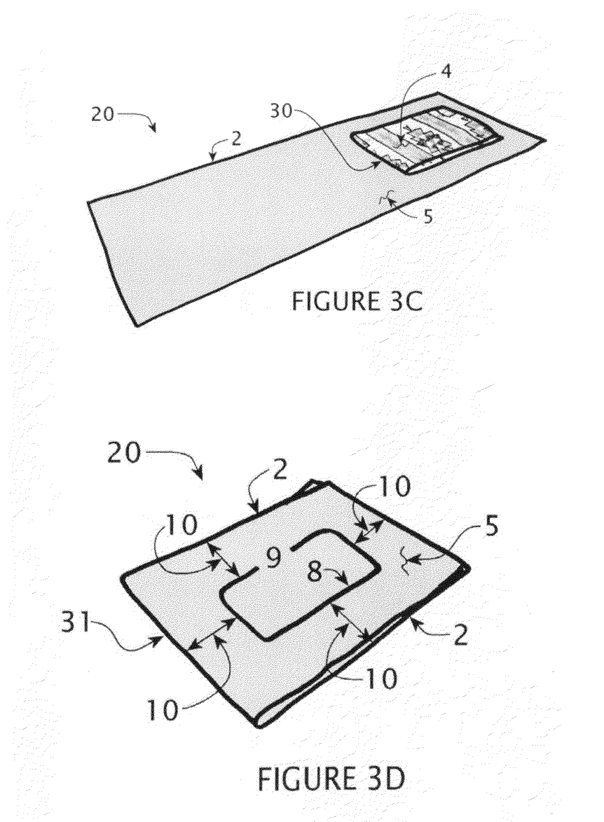

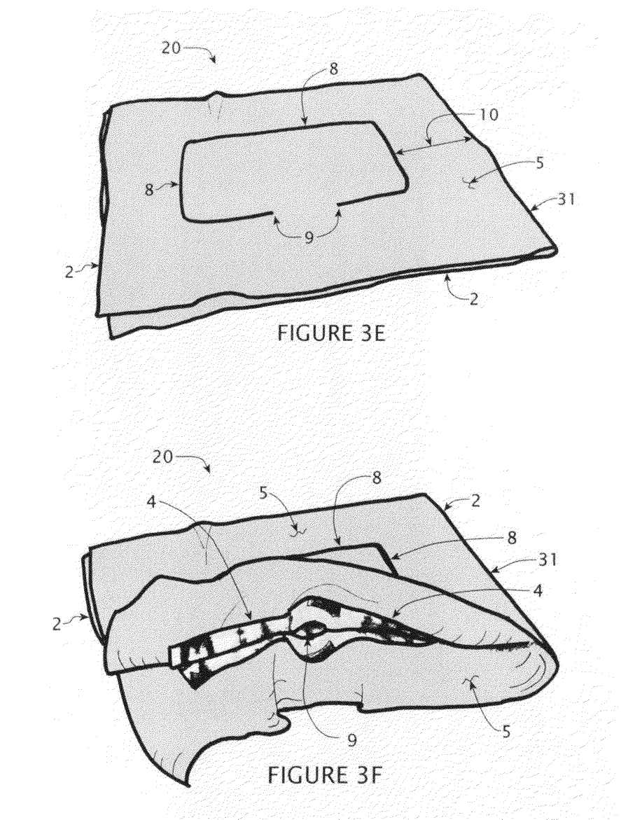

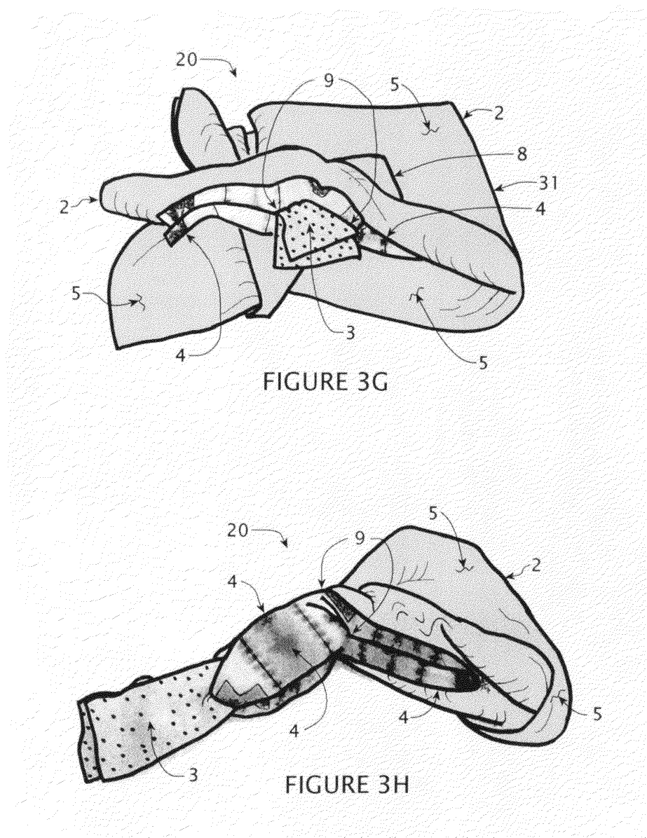

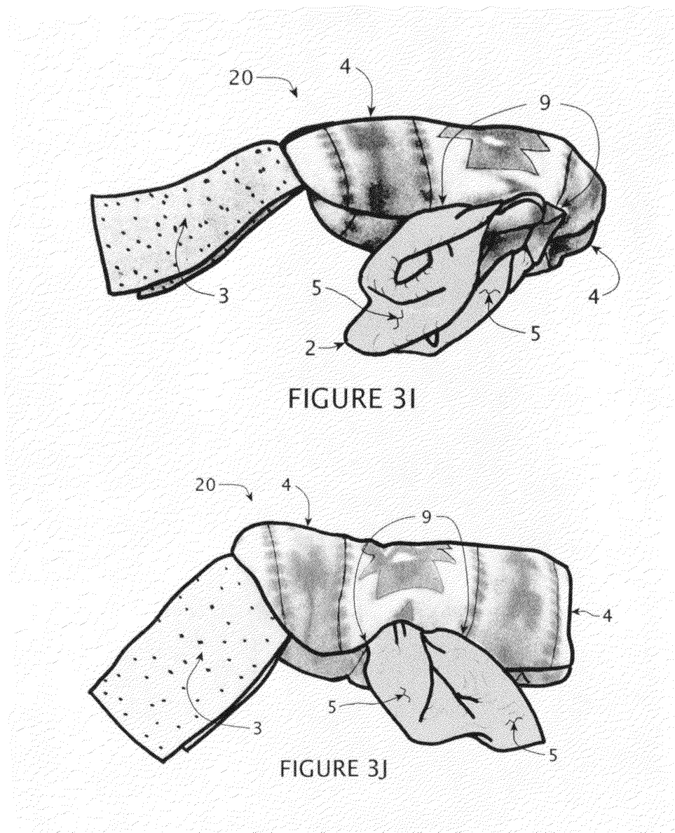

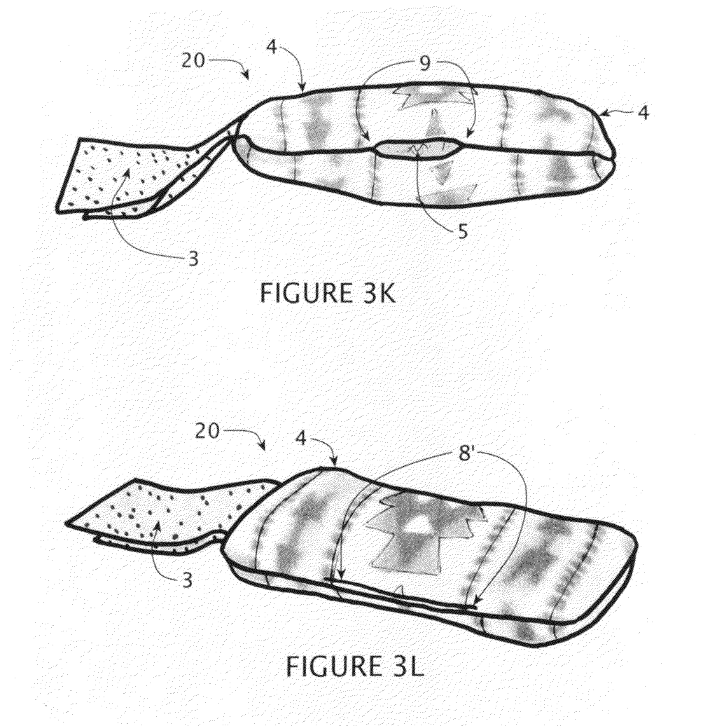

FIGS. 3A-3L depict the first exemplary type of manufacturing process to create an article 20 similar to that shown in FIG. 1, according to one embodiment of the invention.

FIG. 3A depicts the first step in manufacturing which includes an outer layer 4 with a printed pattern for increased attractiveness and an inner layer 2 which will also, once finished, form the filling 5 for the article 20, and a tab 3 or protrusion is also included here. It should be noted that the outer covering 2 and the filling 5 are made from a continuous piece of fabric and once the article 20 is completed, will remain a continuous piece. In this type of manufacturing process the fact that a single piece of fabric 2 becomes the filling 5 yields for example a toy or bed that has increased durability and specifically makes removal of the filling by the animal very difficult.

Turning now to FIG. 3B, the next step is shown where the tab 3 is folded over onto itself. The two ends of the tab 3 will be on the outside of the finished article 20 and the fold of the tab 3 will be on the inside of the finished article 20.

Turning now to FIG. 3C, the printed outer covering 4 is folded over the tab 3 creating a fold 30. The printed fabric 4 will be the outer layer of two layers of fabric, 4 & 2, once the article 20 is finished.

Turning now to FIG. 3D, the fabric 2 which will become the inner layer of two layers is folded over enclosing both the tab 3 and the outer layer of fabric 4 creating a fold 31. It will be understood by those skilled in the art that the fold 31 could be cut at any point in the construction process and the invention is not limited thereto. Next all the layers of fabric are bound together, for example by stitching 8 leaving an opening 9 in the stitching 8 which will be used for turning the article 20 right side out. As noted above, the layers of fabric can be bound together in various ways using thread, glue, heat welding, melting, zipper, hook and loop material, snaps, spring clips, etc., and the invention is not limited thereto. The general shape of the stitching 8 determines the general shape of the finished article 20. The fabric layer 2, which extends beyond the stitching 8, will become the filling 5 once the article 20 is finished. Specifically, the size of the area 10 of the fabric between the stitching 8 and the edge of the layer 2 can be varied. If the size of the area 10 is increased, the amount of filling 5 inside of the finished article 20 will increase, and vice versa, if the size of the area 10 of the fabric between the stitching 8 and the edge of the layer 2 is decreased, the amount of filling 5 inside the finished article 20 will decrease.

Now turning to FIG. 3E, the opening 9 in the stitching 8 is located.

Now turning to FIG. 3F, the fabric layer 2 and the printed fabric layer 4 are spread apart at the opening 9.

Now turning to FIG. 3G, the opening 9 in the stitching 8 is pulled apart and when one reaches inside the opening 9 a person can grasp the tab 3 and start to pull it through the opening 9. This is the first step in turning the article 20 right side out. If the article 20 does not have a tab 3 or protrusion the outer layer of fabric 4 can be grasp from inside the opening 9 to start the process of turning the article 20 right side out and the invention is not limited thereto.

Turning now to FIG. 3H, the article 20 is further turned right side out by pulling on the tab 3 and the fabric 4 which will be coming out of the opening 9. The inner layer of fabric 2 will be following the outer layer 4 and the entire article 20 will be turned right side out. The extra fabric 5 which was part of the inner layer 2 will be turned to the inside of the article 20 and become the filling 5.

Turning now to FIG. 3I, the article 20 is further turned right side out and begins to take shape with the rest of the inner layer 2 and the filling 5 being pushed into the opening 9.

FIG. 3J depicts the article 20 almost completely turned right side out with the last of the filling layer 5 pushed inside of the opening 9 and the outer layers 4 begin to take the shape of the article 20.

FIG. 3K depicts the article 20 completely turned right side out with the last of the filling 5 being pushed inside of the opening 9. Once the invention is turned right side out the additional material 5 becomes the substance that fills the inner cavity 1.

FIG. 3L depicts the last step in this exemplary manufacturing process with the opening 9 being sewn shut with stitching 8′. In the alternative, the opening 9 can be shut or sealed using various known devices such as a zipper, a snap mechanism, a hook and loop device (Velcro®), etc., and the invention is not limited thereto. FIG. 3L depicts a finished toy in the shape of a rectangle with tabs 3 protruding from one end having a printed outer layer 4 and a second inner layer 2 which gives the article 20 increased durability. It should be noted that the outer coverings both the inner layer 2 and the printed outer layer 4 were constructed from one piece of fabric each by utilizing a fold. It is possible to not use a fold and instead use two separate pieces of fabric for a layer and the invention is not limited thereto. This could be used to create an article 20 that has a different color on the top and bottom. One, two, or more layers may be used for increased strength or for other reasons. This manufacturing process can be used with or without tabs 3, fringe or other types of protrusions and the invention is not limited thereto. Also, additional items such as cat nip, squeakers, or other, may be inserted into the opening 9 before it is closed by stitching 8′.

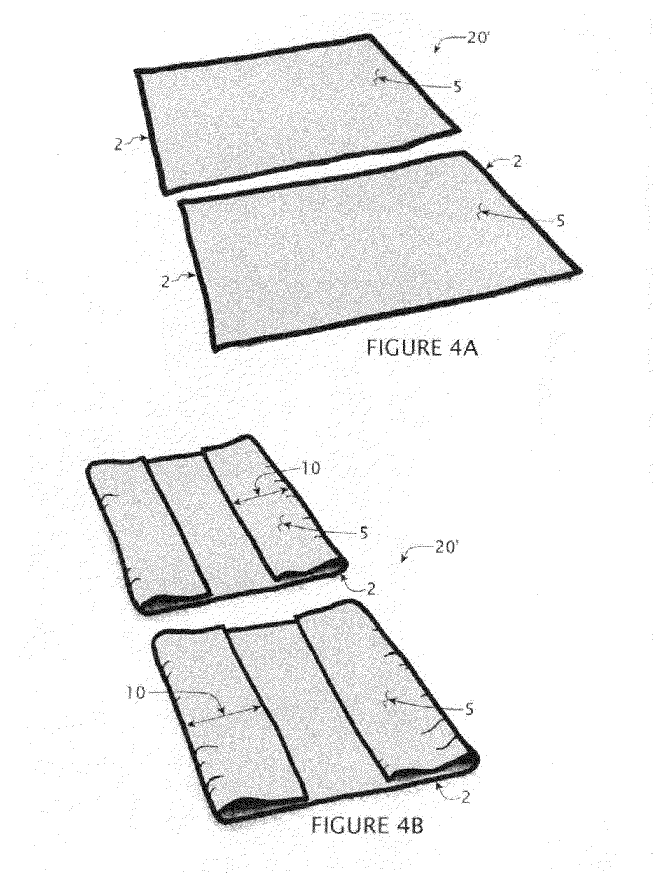

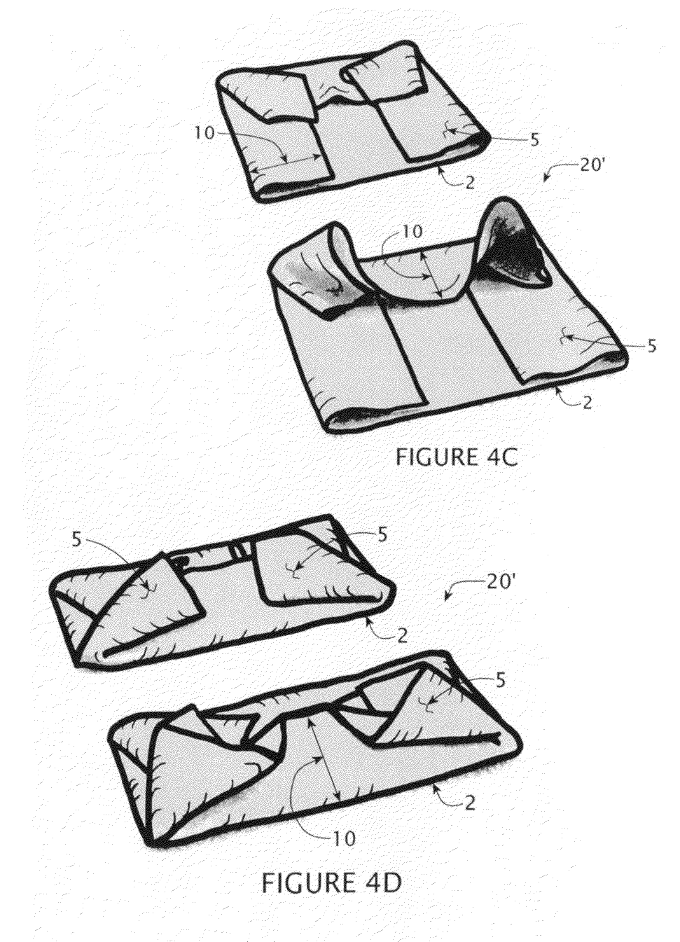

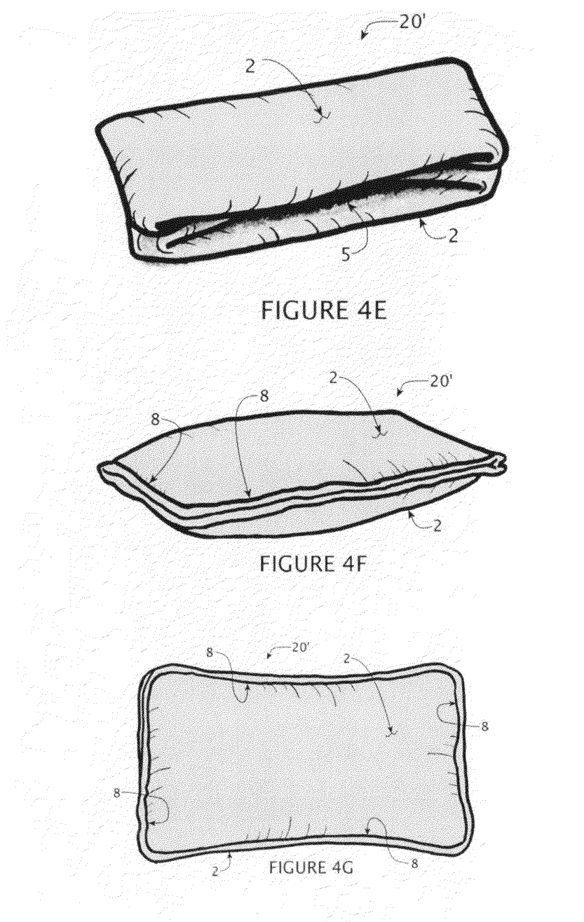

Now turning to FIGS. 4A-4G, a second exemplary type of manufacturing process is depicted to create an article 20′ which is similar to that shown in FIG. 1, but with visible edge stitching.

FIG. 4A depicts the first step in manufacturing which includes two pieces of fabric used to form the outer layers 2 which will be the top and bottom of the article 20′, and will also, once the article 20′ is finished, form the filling 5. It should be noted that the outer covering 2 and the filling 5 are made from a continuous piece of fabric, and once the article 20′ is completed, will remain a continuous piece. In this type of manufacturing process the fact that a single piece of fabric 2 becomes the filling 5 yields an article 20′ that has increased durability and specifically makes removal of the filling by the animal very difficult.

Turning now to FIG. 4B, the first step is to start to form the layers of fabric by turning the layers onto themselves thereby making the filling 5. Each edge needs to be turned into the middle of the article 20′ and FIG. 4B depicts the first two sides being turned in. The fabric layer 2 will become the filling 5 once the article 20′ is finished. Specifically, the size of the area 10 of the fabric can be varied. If the area 10 is increased, the amount of filling 5 inside of the finished article 20′ will increase, and vice versa, if the area 10 of the fabric is decreased, the amount of filling 5 inside the finished article 20′ will decrease.

Now turning to FIG. 4C, the third side of the top and bottom layers 2 is turned into the center of the article 20′ with the desired size overlap 10 which will become the filling 5.

Now turning to FIG. 4D, the fourth and last side of the layer 2 is turned into the middle. Now there are two pieces, top and bottom, each formed the same with four folded sides 10 into the center which when the article 20′ is finished will be the filling 5.

Now as depicted in FIG. 4E both sides are placed together with the filling 5 sides together and the outer layers 2 on the outside. The next step includes binding, for example, sewing using stitching 8, around the edge of the article 20′ to complete the article 20′. As noted above, the stitching 8 can be replace by glue, heat welding, melting, zipper, hook and loop material, snaps, spring clips, etc., and the invention is not limited thereto.

FIG. 4F depicts an elevation view of the article 20′ which has been sewn around the edge with stitching 8 and is complete.

FIG. 4G depicts a plan view of a finished article 20′, for example, a toy or bed, with stitching 8 around the edge. This second exemplary method of manufacturing process can be used with or without tabs 3, fringe or other types of protrusions and the invention is not limited thereto. Also, additional items, cat nip, squeakers, or other, may be inserted between the layers 2 before being sewn shut. The article 20′ can be formed into many different shapes. The edge stitching 8 can add visual appeal. Unlike the other manufacturing methods, this method does not require the article 20′ to be turned right side out. This manufacturing method also results in the finished article 20′, for example, a toy or bed, having the stitches 8 or sewing visible along the edge.

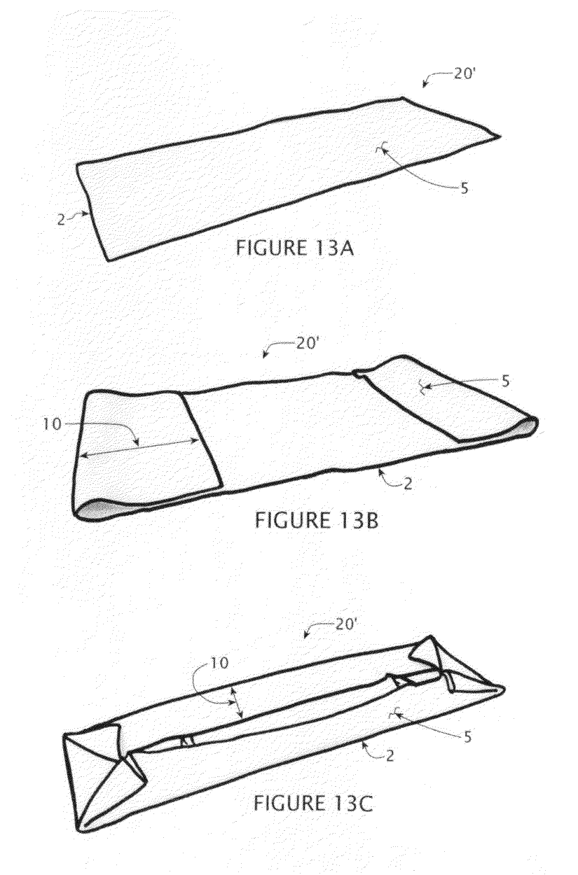

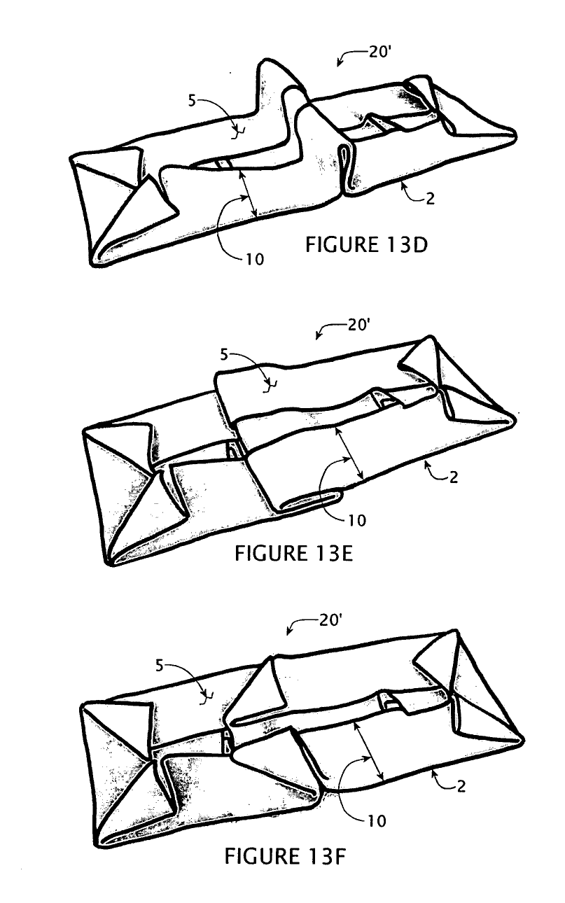

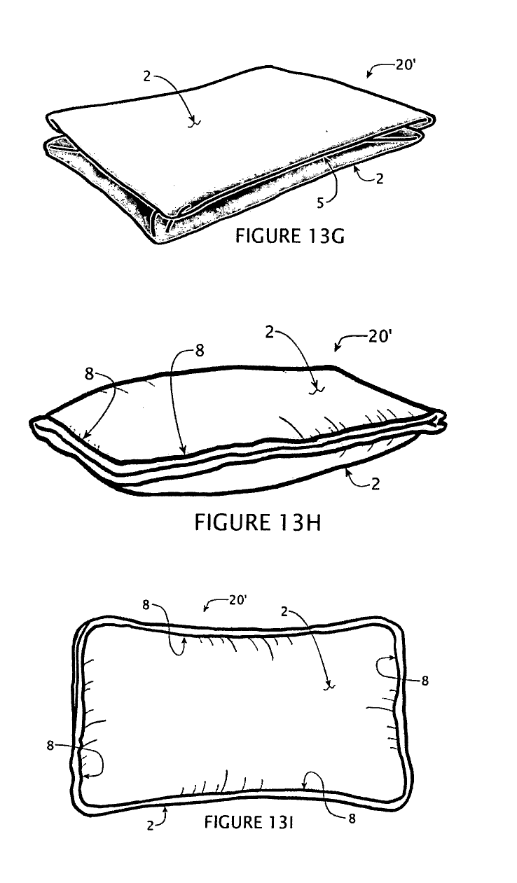

Now turning to FIGS. 13A-13I, a fourth exemplary type of manufacturing process is depicted to create an article 20′ which is similar to that shown in FIG. 1, but with visible edge stitching and created from a single continuous piece of material.

FIG. 13A depicts the first step in manufacturing which includes one piece of fabric used to form the outer layers 2 which will be the top and bottom of the article 20′, and will also, once the article 20′ is finished, form the filling 5. It should be noted that the outer covering 2 and the filling 5 are made from a continuous piece of fabric, and once the article 20′ is completed, will remain a single continuous piece of fabric. In this type of manufacturing process, the fact that a single piece of fabric 2 becomes the filling 5 yields an article 20′ that has increased durability and specifically makes removal of the filling by the animal very difficult.

Turning now to FIG. 13B, the first step is to start to form the layers of fabric by turning the layers onto themselves thereby making the filling 5. Each edge needs to be turned into the middle of the article 20′ and FIG. 13B depicts the first two edges being turned in. The fabric layer 2 will become the filling 5 once the article 20′ is finished. Specifically, the size of the area 10 of the fabric can be varied. If the area 10 is increased, the amount of filling 5 inside of the finished article 20′ will increase, and vice versa, if the area 10 of the fabric is decreased, the amount of filling 5 inside the finished article 20′ will decrease.

Now turning to FIG. 13C, the third and fourth sides of the fabric 2 are turned towards the center of the article 20′ with the desired size overlap 10 which will become the filling 5.

Now turning to FIG. 13D, the middle section of the layer 2 is folded into the middle to form an overlapping fold.

Now as depicted in FIG. 13E, the middle section of overlapped fabric is flattened to one side.

Now as depicted in FIG. 13F, the middle section of overlapped fabric is again folded onto itself, towards the center of the article.

Now as depicted in FIG. 13G, the article is folded in half so as to contain and conceal the folded fabric 5. The next step includes binding, for example, sewing around the edge of the article 20′ to complete the article 20′. As noted above, the binding can be done using thread, glue, heat welding, melting, zipper, hook and loop material, snaps, spring clips, etc., and the invention is not limited thereto.

FIG. 13H depicts an elevation view of the article 20′ which has been sewn around the edge with stitching 8 and is complete.

FIG. 13I depicts a plan view of a finished article 20′, for example, a toy or bed, with stitching 8 around the edge. This fourth exemplary method of manufacturing process can be used with or without tabs 3, fringe handles, or other types of protrusions and the invention is not limited thereto. Also, additional items, cat nip, squeakers, rope, handles, or other, may be inserted between the layers 2 before being sewn shut. The article 20′ and can be formed into many different shapes. The edge stitching 8 can add visual appeal. Unlike the other manufacturing methods, this method does not require the article 20′ to be turned right side out. This manufacturing method also results in the finished article 20′, for example, a toy or bed, having the stitches 8 or sewing visible along the edge.

In another embodiment of the invention, multiple layers of fabric could be used for increased strength.

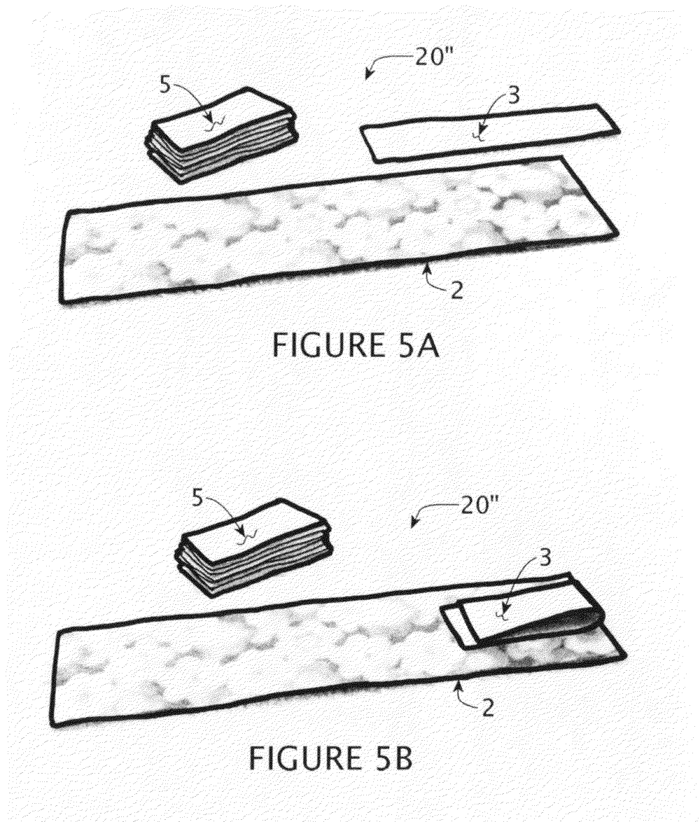

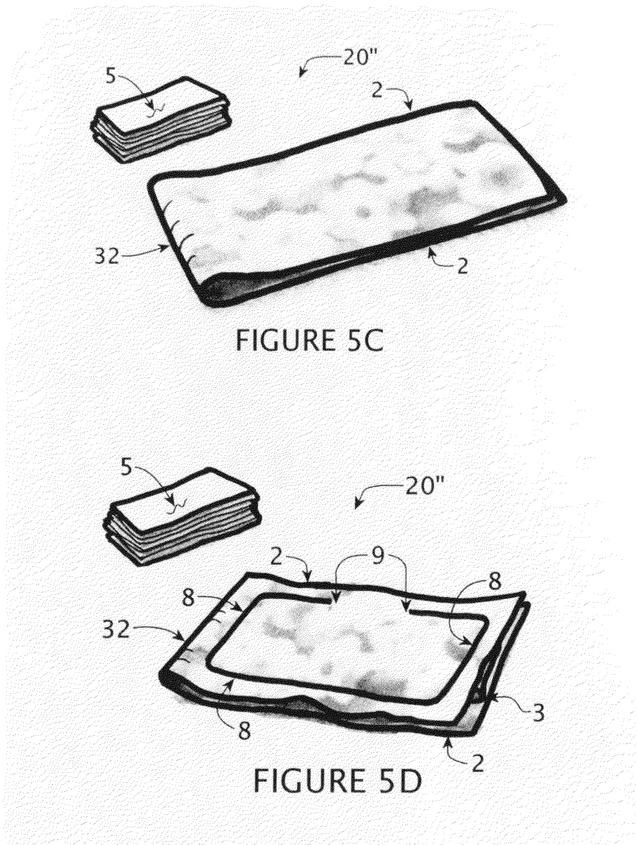

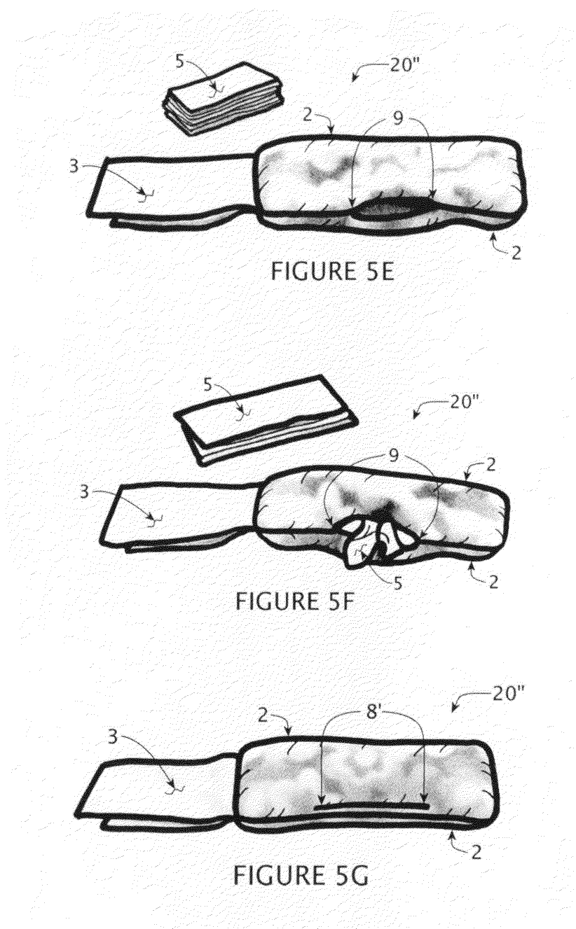

Turning now to FIGS. 5A-5G, a third exemplary type of manufacturing process is depicted to create an article 20″.

FIG. 5A depicts the first step in manufacturing which includes the parts necessary for manufacturing being, an outer layer 2 shown here a printed pattern for increased attractiveness is used. The filling 5 is made from the same type of fabric as 2 and may be a print or a solid color, and a tab 3, or protrusion is also included here. It should be noted that the outer covering 2 and the filling 5 may be made from the same type of fabric or different fabric and multiple layers can be used to increased strength. In this type of manufacturing process, the filling 5 yields an article 20″ that if the filling is removed it will be in large size pieces as compared to the normal type of stuffing found in most common stuffed toys. Also, since the filling 5 is the same material as the covering 2 the article 20″ has one common smell and texture thereby making discovery and removal of the inner filling from the article by the animal less desirable than as is experienced with most common stuffed animal toys or beds.

Turning now to FIG. 5B, the next step shown is to prepare the tab and includes placing the tab 3 on the edge of the fabric 2 and folding it over onto itself. The two ends of the tab 3 will be on the outside of the finished article 20″ and the fold of the tab 3 will be on the inside of the finished article 20″.

Turning now to FIG. 5C, the outer layer 2 is folded in half inclosing the tab 3 and creating a fold 32. It will be understood by those skilled in the art that the fold 32 could be cut at any point in the construction process or two pieces of fabric can be used and the invention is not limited thereto. The printed fabric 2 will be the outer layer once the article 20″ is finished.

Turning now to FIG. 5D, the article 20″ is sewn together with stitching 8 leaving an opening 9 which will be used for turning. Note the folded edge of the tab 3 shows along the edge of the layer 2. The tab 3 is secured to the article 20″ by the stitching 8. Next the article 20″ will be turned right side out. To turn the invention right side out one needs to reach into the opening 9 and grab the tab 3 or some of the fabric 2 and pull it thought the opening 9 until the article 20″ turns right side out. Turning the article 20″ right side out is similar to the technique previously explained in the first exemplary manufacturing method for turning illustrated in FIGS. 3A-3L.

Turning now to FIG. 5E, the article 20″ is depicted after it has been turned right side out. The opening 9 is seen in FIG. 5E.

Now turning to FIG. 5F, pieces of the filling 5 are placed inside of the opening 9. The hardness of the article 20″ can vary with different amounts of the filling 5 being inserted into the article 20″. The filling 5 shown here is depicted as multiple pieces which are placed into the inner cavity though the opening 9. It should be understood that the filling for this technique of manufacturing can consist of one (1) large piece of fabric or multiple pieces of fabric or no pieces at all. For illustrative purposes, multiple pieces of filling 5 are depicted here and the invention is not limited thereto. The fabric filling 5 is made from the same material as the outer layers 2, however either may be printed or solid colors or patterned fabric of any mixture or combination thereof.

Now turning to FIG. 5G, the final step is to stitch 8′ the opening 9 shut. FIG. 5G shows a finished article 20″. One, two, or more layers for the outer covering 2 may be used for increased strength. This manufacturing process can be used with or without tabs 3, fringe or other types of protrusions and the invention is not limited thereto. Also, additional items such as cat nip, squeakers, or other, may be inserted into the opening 9 before it is closed with stitching 8′. In the alternative, the opening 9 can be shut or sealed using various known devices such as a zipper, a snap mechanism, a hook and loop device (Velcro®), spring clip, heat welded, melting, etc., and the invention is not limited thereto. Since the filling 5 is the same material as the covering 2 the article 20″ has one common smell and texture thereby making discovery and removal of the inner filling from the article 20″ by the animal less desirable than as is experienced with most common stuffed animal toys or beds.

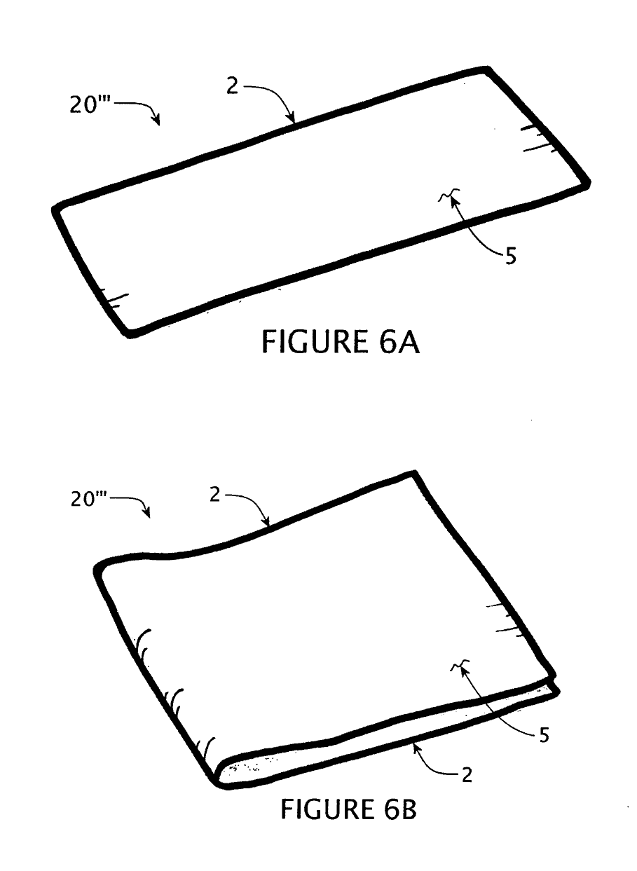

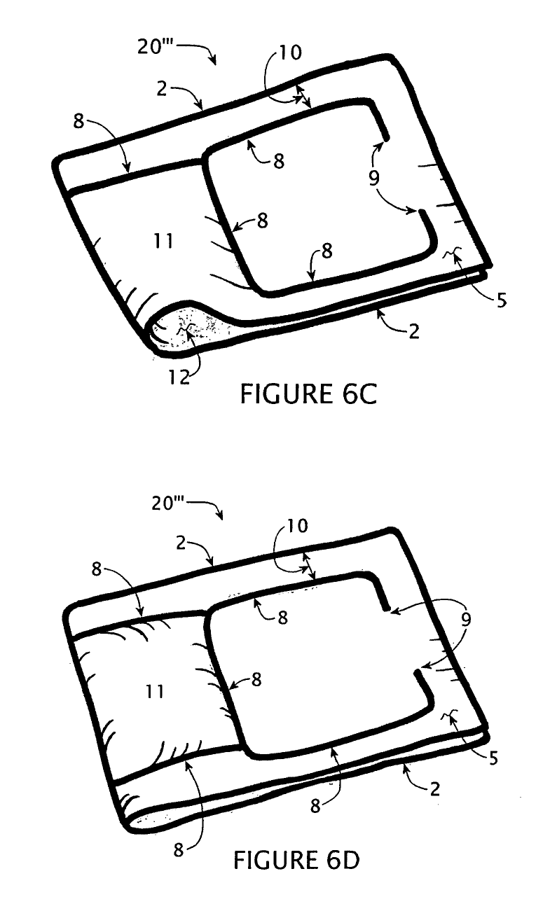

Turning now to FIGS. 6A-6D, a fourth exemplary type of manufacturing process is depicted for manufacturing the article 20′″ with a modification or variation of an internal pocket. The pocket will be located on the inside of the article 20′″ and made from a continuous piece of the same fabric used to form the outer layers 2. Such a pocket can be added to the article 20, 20′, 20″, or 20′″ in any of the manufacturing processes and can increase attractiveness.

Turning now to FIG. 6A, the piece of fabric 2, while remaining continuous, will also become the filling 5 and the pocket. In this example, one outer layer 2 of fabric is used but more outer layers can be used for increased durability and the invention is not limited thereto.

In the first step of manufacturing illustrated in FIG. 6B, the layer of fabric 2 is folded over.

Next as shown in FIG. 6C, the article 20′″ is sewn together with stitching 8 and an opening 9 is left for turning the article 20′″ right side out. The process of turning the article 20′″ right side out will result in the pocket 11 ending up inside of the finished article 20′″. Still referring to FIG. 6C, the pocket 11 is created by locating the stitching 8 so as to form two sides of the pocket 11 and the fold in the fabric is used to form a third side of the pocket 11. If two pieces of fabric are used (not one piece folded) the fold can be replaced with stitching joining the two layers. Still referring to FIG. 6C, the inside 12 of the pocket 11 can be seen. The inside 12 of the pocket 11 shall be filled with squeakers, cat nip, or other items and the invention is not limited thereto.

In FIG. 6D, the closing of the pocket 11 is sewn shut with stitching 8. Once the pocket 11 is sewn shut, the article 20′″ is turned right side out through the opening 9 in the sewing, as covered in the prior manufacturing processes, and the opening 9 is closed by stitching. In the alternative, the opening 9 and or the pocket 11 can be shut or sealed using various known devices such as a zipper, a snap mechanism, a hook and loop device (Velcro®), etc., making the pocket 11 or the article refillable and the invention is not limited thereto. A pocket 11 can be combined with tabs, protrusions, insertion of squeakers, or other items and the shape of the article 20′″ can be various shapes and the invention is not limited thereto. Once the article 20′″ is finished, the pocket 11 provides containment for the inserted item in addition to the fabric layers 2 and may help prolong the lifespan of the article 20′″ and protect the item or contents of the pocket 11 from being dislodged from the article 20′″. Multiple layers may be used to increase strength.

FIG. 7 depicts a modification or variation of the invention for increased attractiveness and shows the article 20 in the shape of a triangle 13 and having six fabric tabs 3. The article 20 can be made in a variety of shapes and have a variety of tabs 3, or other protrusions to increase its appeal to animals and owners and the invention is not limited thereto. Multiple outer layers may be used to increase strength. The article 20 depicted here is manufactured by first sewing the layers together and then turning the article 20 right side out, and once finished, the article 20 has concealed stitching.

FIG. 8 depicts a modification or variation of the invention for increased attractiveness and shows the article 20 in the shape of an oval having fringe 14, and having the fringe 14 around the entire perimeter of the article 20. For illustrative purposes the term fringe refers to a protrusion similar to a tab 3, but in a more narrow size and the invention is not limited thereto. The fringe 14 could be replaced by tabs 3, string, at least one handle, rope, or other items on zero, one, or more sides, and encompassing none, a portion of, or the entire perimeter of the article 20 and the invention is not limited thereto. The article 20 depicted here is manufactured by first sewing the layers together and then turning the article 20 right side out, and once finished, the article 20 has concealed stitching.

FIG. 9 depicts a modification or variation of the invention and shows an article 20 in the shape of a rectangle having a rope “pull” 15 protruding from the article 20. Such a protrusion could be a fabric tab 3, fringe 14, or other types of items to increase attractiveness of the article 20 and be placed on zero, one, or more sides, and encompassing none, a portion of, or the entire perimeter of the article 20 and the invention is not limited thereto. The article 20 depicted here is manufactured by first sewing the layers together and then turning the article 20 right side out, and once finished, the article 20 has concealed stitching.

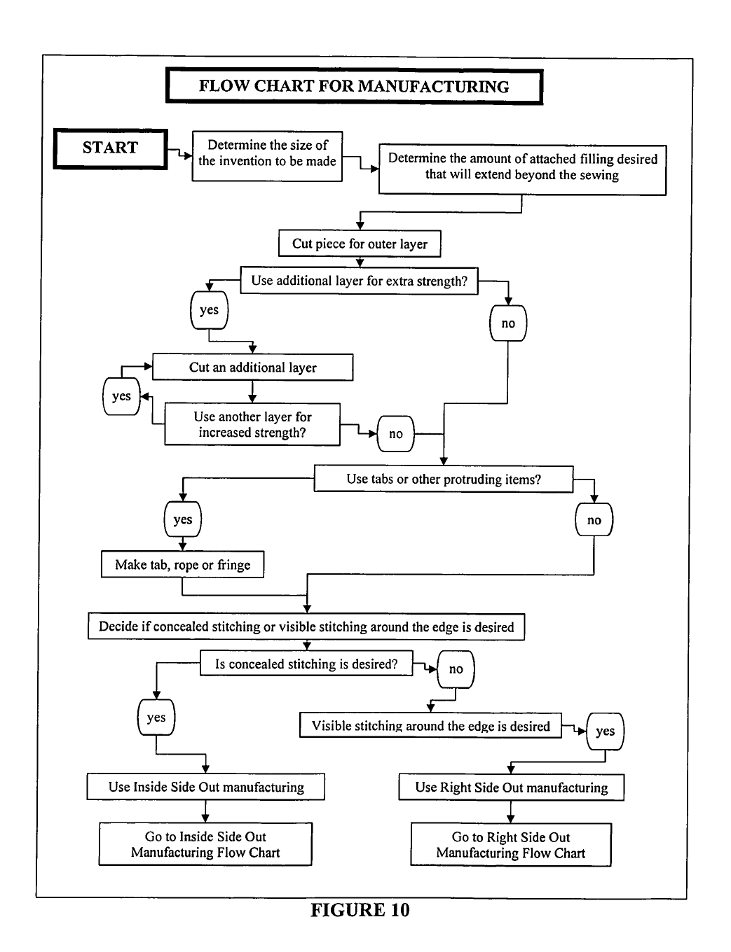

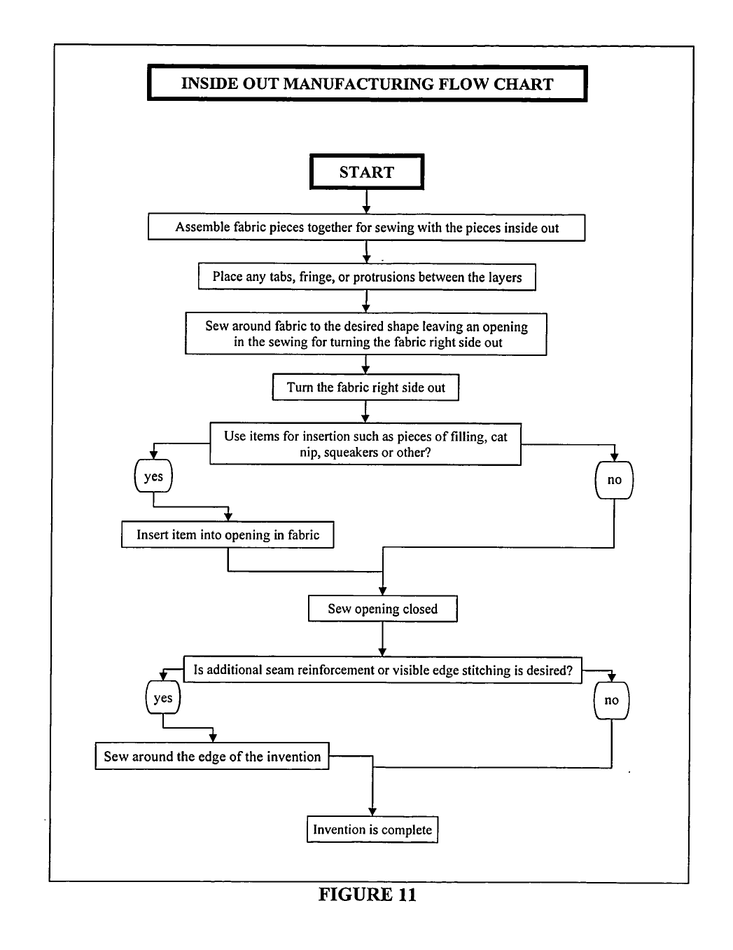

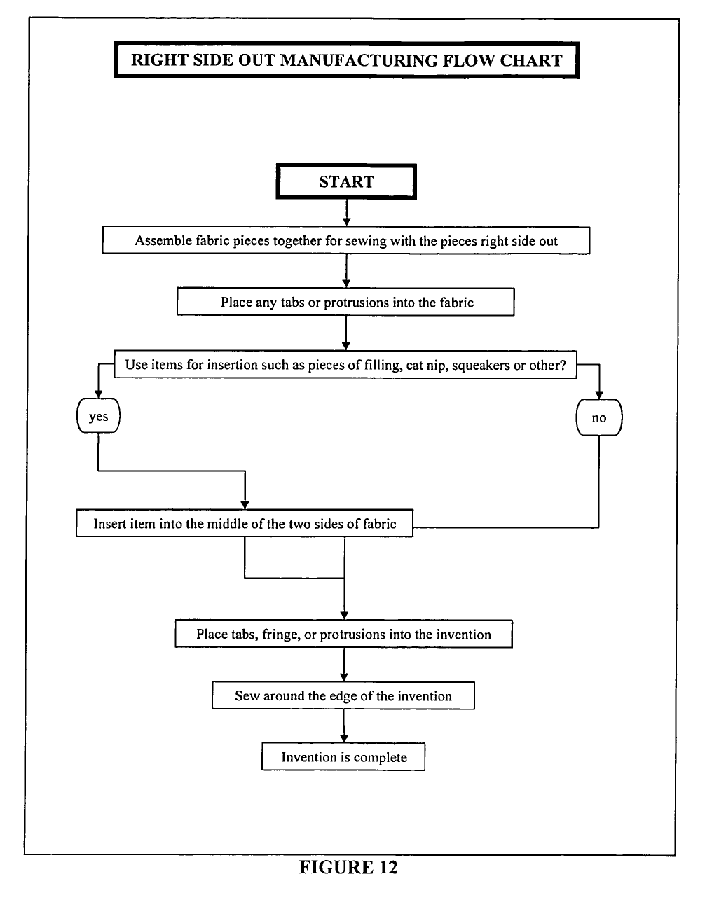

FIGS. 10-12 depict flow charts to assist in navigating the possible variations of the manufacturing processes. For illustrative purposes only, the flow charts summarize two methods for manufacturing; first the Inside Out Manufacturing method (FIG. 11), and secondly, the Right Side Out Manufacturing method (FIG. 12). It is to be understood that many different variations of manufacturing are possible and for illustrative purposes only two are described here and it is to be understood that the present invention is not limited to any specific type of manufacturing.

In FIG. 10, the first part of the manufacturing process is depicted wherein the size and shape of the article 20 is determined. The amount of filling is also determined and the size of the fabric should be cut to allow for the finished size of the article 20 and any additional filling that will be a continuous part of the layers. Specifically, the distance between the edge of the fabric and the stitching will determine the amount of attached filling. More fabric equals more filling, and vice versa, less fabric equals less filling. The fabric is then cut to the required size. If additional layers for strength are desired additional layers can be cut. Generally speaking, the outer most layer, the one visible when the article 20 is finished, would be the more visually appealing fabric and the inner layer can be a solid fabric. Normally, printed fabrics are more costly than solid fabrics. The difference in fabric cost can be considered if a multi layered article 20 is being made. Specifically, the more expensive printed outer layer can be of a size to cover the article 20 and wrap around for sewing with the inner layer or solid color layer being a larger size, and that larger size of the solid color inner layer more reasonably priced fabric can be used to create the filling. This will help to keep manufacturing costs lower by using a smaller piece of the printed fabric when compared to the solid fabric. Also, any additional layers can be cut at this time. It is conceivable that more than two layers can be used where increased strength is desired. Next, it should be decided if any tabs, fringe or other protrusions are to be included in the article 20 and such items prepared and cut to size.

The next step in manufacturing is to decide if the article 20 will be constructed right side out or inside out. Right side out manufacturing can be used for fabrics that are large or cumbersome to turn right side out, or it can provide a visually appealing edge stitching. The inside out manufacturing method can be used to make a finished article where the seams are concealed within the body of the article 20.

FIG. 11 depicts a flow chart for inside out manufacturing method and is continued from the flow chart depicted in FIG. 10. This process is also illustrated in FIGS. 3A-3L and FIGS. 5A-5G. The first step in the flow chart of FIG. 11 is to assemble the fabric pieces together for sewing with the right sides of the fabric face to face and touching along with insertion of any tabs or protrusions. The next step is to sew the article 20 together leaving an opening in the stitching for turning the fabric right side out. Any tabs or protrusions before turning will now be on the inside of the article 20 and attached by the stitching of the previous step. Next the article 20 is turned right side out. Now, any tabs or protrusions will be on the outside of the article 20, and any items such as cat nip, squeakers, or additional filling can be inserted into the opening and the invention is not limited thereto. The last step is to sew the opening shut. If visible edge stitching is desired, the article 20 can be sewn around the edge giving additional strength or an appealing stitching around the edge.

FIG. 12 depicts a flow chart for right side out manufacturing method and is continued from the flow chart depicted in FIG. 10. This process is also illustrated in FIGS. 4A-4G and FIGS. 13A-13I. The first step in the flow chart of FIG. 12 is to assemble the fabric piece or pieces together for sewing with the right sides of the fabric facing to the outside and the filling which is an extension of the outer layer, folded to the inside. Any items to be inserted in the toy such as squeakers, or additional pieces of filling, should be placed into the inner cavity and the invention is not limited thereto. Any tabs, fringe, or protrusions should also be placed into the article 20′. The last step includes the edges being sealed together, most commonly by sewing around the edge completing the article 20′.

According to one embodiment of the invention, it will be understood that any fold in the material in each article can be cut to create at least two pieces of material without departing from the scope and claims of the invention and the invention is not limited thereto.

Depending on the type of material used to form the invention it is possible that stitching, heat, glue or other types of methods for adhering the layers together may be used.

As described above, some of the inventive articles of manufacture are for use by animals. Animal owners are advised to heed the following warnings. Please remove packaging before giving the article to your pet. Supervise your pet while playing with the article. Do not leave the article unattended with animals, and particularly those animals that tend to eat their toys. Immediately discard a damaged or worn article. Some articles may contain small parts that may pose a choking hazard to animals or children. Keep the article out of reach of unsupervised children.

Those skilled in the art will now appreciate that, according to one embodiment of the invention, an article of manufacture such as an animal toy, flying disk, or bed has been described that provides the advantages of being filled, soft and durable, yet remaining malleable and attractive to an animal and owner. The article disclosed herein has a soft full feel and can be easily compressed in the mouth of a dog, cat or other animal, yet has a low risk of releasing its contents. According to another embodiment of the invention, the article of manufacture may be products used by humans such as children's toys, human bedding and pillows, furniture, environmental products such as absorbent pads and booms, etc., and the invention is not limited thereto. Furthermore, the inventive article disclosed herein can be manufactured relatively easily and inexpensively. It will also be appreciated that the present invention provides an improved method for forming articles such as an animal toy, flying disk or bed. While the present invention has been described with respect to preferred embodiments thereof, such description is for illustrative purposes only, and is not to be construed as limiting the scope of the invention. It will be understood by one skilled in the art that the steps of manufacturing the article may be performed in different order and various steps may be done by hand or machine or a combination of both and the invention is not limited thereto. Various modifications and changes may be made to the described embodiments by those skilled in the art without departing from the true spirit and scope of the invention as defined by the appended claims.

An animal toy, flying disk or bed consisting of an outer layer constructed from one or more pieces of flexible material, fabric, fleece, nylon, canvas, leather, rawhide, animal parts, fiber, etc., having a variable size and variable cross sectional area and possessing an inner volume filled with continuous material not separated or disconnected from the covering.

Such filling of the inner volume is accomplished during the manufacturing process multiple ways, some examples are when the sewn layer(s) are turned right side out to create the finished object or the object is first formed and then the edges sewn together.

The animal toy, flying disk or bed is durable and will not release the inner contents easily as the filling can be an integral part of the outer covering.

The animal toy, flying disk or bed does not contain any stuffing as in the traditional sense, as can be found in most soft stuffed items.

The animal toy, flying disk or bed may have an inner cavity which is filled with the same material as the outer layer(s) giving the article one common smell and texture, thereby making discovery and removal of the inner filling from the article less desirable to an animal than presently seen with common stuffed animal toys and beds which are stuffed with material(s) different from the outer layer.

The animal toy, flying disk or bed may be constructed of multiple layers to increase strength and the density of the filling.

The animal toy, flying disk or bed may have a pocket sewn into the filling. The pocket may be located within the inner cavity of the finished invention.

The animal toy, flying disk or bed may contain its such as cat nip, squeakers, noise makers, aromatic objects, cat nip, cedar wood chips, or other auditory, tactile items which may be attractive to the animal and inserted prior to the invention being finished.

The animal toy, flying disk or bed may have protruding fringe, at least one tab, rope, string, at least one handle, or other items on zero, one, or more sides and encompassing none, a portion of, or the entire perimeter of the invention.

The animal toy, flying disk or bed which if constructed from common fabrics the invention may be easily cleaned in a standard household washing machine and dryer.

The animal toy, flying disk or bed during manufacturing may be first constructed inside out and upon finishing be turned right side out and any opening closed resulting in concealed sewing inside the invention, except for the closure.

The animal toy, flying disk or bed during manufacturing may be constructed by first forming the toy or bed and then sewing the edges together resulting in visible sewing along the edge.

The animal toy, flying disk or bed may be constructed using any or a combination of methods of manufacturing combined together, for example, the invention may be sewn inside out first, turned right side out, and then the edge sewn a second time to give added strength or visual appeal.

The animal toy, flying disk or bed may be constructed of various sizes to accommodate animals both domestic and wild which are receiving care or support from people.

The animal toy, flying disk or bed may be manufactured by using thread and sewing a straight stitch, glue, heat welded, melting, zipper, hook and loop material, snaps, spring clips or any other means suitable to bind the material used to construct the invention.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A stuffed article, comprising:
a single piece of material having a first part and a second part, wherein the first part of the single piece of material forms an outer cover of the stuffed article, wherein the second part of the single piece of material is positioned in an inner cavity inside the outer cover to form the stuffing of the stuffed article; and
binding along at least a portion of a perimeter of the outer cover to hold the stuffed article together.

2. The stuffed article according to claim 1, wherein the binding is comprised by at least one of the group comprising thread, glue, heat welding, melting, zipper, hook and loop material, snaps, and spring clips.

3. The stuffed article according to claim 1, wherein the inner cavity contains at least one of the group comprising squeakers, noise makers, aromatic objects, catnip, cedar chips, auditory objects, and tactile objects.

4. The stuffed article according to claim 1, wherein at least one of the group comprising at least one tab, fringe, string, at least one handle, and rope protrude from the outer cover of the stuffed article.

5. The stuffed article according to claim 1, wherein the stuffed article is at least one of the group comprising: an animal toy, flying disk, animal bed, children's toys, human bedding and pillows, and environmental products.

6. The stuffed article according to claim 1, wherein the material is from at least one of the group comprising: fabric, canvas, denim, fleece, nylon, rubber, plastic, leather, rawhide, animal parts, and fiber.

7. The stuffed article according to claim 1, wherein a shape of the stuffed article is determined by shape of the binding.

8. The stuffed article according to claim 1, further comprising:
a sealed pocket formed by at least some of the second part of the single piece of material positioned in the inner cavity, wherein the sealed pocket contains at least one of the group comprising squeakers, noise makers, aromatic objects, catnip, cedar chips, auditory objects, and tactile objects.

9. The stuffed article according to claim 1, wherein said single piece of fabric is cut into two pieces, wherein at least a portion of each piece is used to form the outer cover.

10. A stuffed article, comprising:
a first piece of material having a first section and a second section wherein the first section of the first piece of material forms part of an outer cover of the stuffed article;
a second piece of material having a first section and a second section wherein the first section of the second piece of material forms part of the outer cover of the stuffed article, wherein the second sections of the first and second pieces of material are positioned in an inner cavity inside the outer cover to form the stuffing of the stuffed article; and
binding along at least a portion of a perimeter of the outer cover for binding together portions of the first sections of the first and second pieces of material to hold the stuffed article together.

11. The stuffed article according to claim 10, wherein the binding is comprised by at least one of the group comprising thread, glue, heat welding, melting, zipper, hook and loop material, snaps, and spring clips.

12. The stuffed article according to claim 10, wherein the inner cavity contains at least one of the group comprising squeakers, noise makers, aromatic objects, catnip, cedar chips, auditory objects, and tactile objects.

13. The stuffed article according to claim 10, wherein at least one of the group comprising at least one tab, fringe, string, at least one handle, and rope protrude from the outer layer of the stuffed article.

14. The stuffed article according to claim 10, wherein the stuffed article is at least one of the group comprising: an animal toy, flying disk, animal bed, children's toys, human bedding and pillows, and environmental products.

15. The stuffed article according to claim 10, wherein the material is from at least one of the group comprising: fabric, canvas, denim, fleece, nylon, rubber, plastic, leather, rawhide, animal parts, and fiber.

16. The stuffed article according to claim 10, wherein a shape of the stuffed article is determined by shape of the binding.

17. The stuffed article according to claim 10, wherein the first section of the first piece of material forms substantially half of the outer cover.

18. The stuffed article according to claim 10, further comprising: a sealed pocket formed from at least some of the second sections of the first and second pieces of material positioned in the inner cavity, wherein the sealed pocket contains at least one of the group comprising squeakers, noise makers, aromatic objects, catnip, cedar chips, auditory objects, and tactile objects.

19. A method for manufacturing a stuffed article, comprising the steps of:
folding a single piece of material so as to create overlapping upper and lower layers of material;
binding together a portion of the upper and lower layers wherein the binding is performed inside a perimeter of the overlapping upper and lower layers of material, wherein a gap is left in the binding, wherein the binding creates an inner area inside the binding and an outer area outside the binding;
pulling the entire piece of material through the gap in the binding thereby turning the folded piece of material inside out and creating the stuffed article, wherein the material in the inner area creates an outer covering of the stuffed article and the material in the outer area creates the stuffing of the stuffed article in an inner cavity inside the outer cover; and
binding the gap together to close the outer covering.

20. The method for manufacturing a stuffed article according to claim 19, wherein the binding comprises at least one of the group comprising thread, glue, heat welding, melting, zipper, hook and loop material, snaps, and spring clips.

21. The method for manufacturing a stuffed article according to claim 19, further comprising the step of:
inserting at least one of the group comprising squeakers, noise makers, aromatic objects, catnip, cedar chips, auditory objects, and tactile objects inside the stuffed article before the gap is closed in the outer covering.

22. The method for manufacturing a stuffed article according to claim 19, further comprising the step of:
attaching at least one of at least one tab, fringe, string, at least one handle, and rope so as to protrude from the outer covering of the stuffed article.

23. The method for manufacturing a stuffed article according to claim 19, wherein the stuffed article is at least one of the group comprising: an animal toy, flying disk, animal bed, children's toys, human bedding and pillows, and environmental products.

24. The method for manufacturing a stuffed article according to claim 19, wherein the material is from at least one of the group comprising: fabric, canvas, denim, fleece, nylon, rubber, plastic, leather, rawhide, animal parts, and fiber.

25. The method for manufacturing a stuffed article according to claim 19, wherein a shape of the stuffed article is determined by shape of the binding.

26. The method for manufacturing a stuffed article according to claim 19, further comprising the step of:
creating a sealed pocket formed by at least some of the material stuffed in the inner cavity, wherein the sealed pocket contains at least one of the group comprising squeakers, noise makers, aromatic objects, catnip, cedar chips, auditory objects, and tactile objects.

27. A method for manufacturing a stuffed article, comprising the steps of:
folding a first piece of material into a desired shape;
folding a second piece of material into the desired shape; and
binding said first and second pieces of material thereby creating the stuffed article, wherein first sections of the first and second pieces of material form an outer cover and second sections of the first and second pieces of material form stuffing for the stuffed article.

28. The method for manufacturing a stuffed article according to claim 27, wherein the binding comprises at least one of the group comprising thread, glue, heat welding, melting, zipper, hook and loop material, snaps, and spring clips.

29. The method for manufacturing a stuffed article according to claim 27, further comprising the step of:
inserting at least one of the group comprising squeakers, noise makers, aromatic objects, catnip, cedar chips, auditory objects, and tactile objects inside the stuffed article before the gap is closed in the outer covering.

30. The method for manufacturing a stuffed article according to claim 27, further comprising the step of:
attaching at least one of at least one tab, fringe, string, at least one handle, and rope so as to protrude from the outer covering of the stuffed article.

31. The method for manufacturing a stuffed article according to claim 27, wherein the stuffed article is at least one of the group comprising: an animal toy, flying disk, animal bed, children's toys, human bedding and pillows, and environmental products.

32. The method for manufacturing a stuffed article according to claim 27, wherein the material is from at least one of the group comprising: fabric, canvas, denim, fleece, nylon, rubber, plastic, leather, rawhide, animal parts, and fiber.

33. The method for manufacturing a stuffed article according to claim 27, wherein a shape of the stuffed article is determined by shape of the binding.

34. A method for manufacturing a stuffed article, comprising the steps of:
placing a first piece of material over a second piece of material so that the first and second pieces of material at least partially overlap;
binding together a portion of the first and second pieces of material wherein the binding is performed inside a perimeter of the overlapping materials, wherein a gap is left in the binding, wherein the binding creates an inner area inside the binding and an outer area outside the binding;
pulling the first and second pieces of material through the gap in the binding thereby turning the bound pieces of materials inside out and creating the stuffed article, wherein the material in the inner area creates an outer covering of the stuffed article and the material in the outer area creates the stuffing of the stuffed article in an inner cavity inside the outer cover; and
binding the gap together to close the outer covering.

35. The method for manufacturing a stuffed article according to claim 34, wherein the binding comprises at least one of the group comprising thread, glue, heat welding, melting, zipper, hook and loop material, snaps, and spring clips.

36. The method for manufacturing a stuffed article according to claim 34, further comprising the step of:
inserting at least one of the group comprising squeakers, noise makers, aromatic objects, catnip, cedar chips, auditory objects, and tactile objects inside the stuffed article before the gap is closed in the outer covering.

37. The method for manufacturing a stuffed article according to claim 34, further comprising the step of:
attaching at least one of at least one tab, tabs, fringe, string, at least one handle and rope so as to protrude from the outer covering of the stuffed article.

38. The method for manufacturing a stuffed article according to claim 34, wherein the stuffed article is at least one of the group comprising: an animal toy, flying disk, animal bed, children's toys, human bedding and pillows, and environmental products.

39. The method for manufacturing a stuffed article according to claim 34, wherein the material is from at least one of the group comprising: fabric, canvas, denim, fleece, nylon, rubber, plastic, leather, rawhide, animal parts, and fiber.

40. The method for manufacturing a stuffed article according to claim 34, wherein a shape of the stuffed article is determined by shape of the binding.

41. The method for manufacturing a stuffed article according to claim 34, further comprising the step of:
creating a sealed pocket formed by at least some of the material stuffed in the inner cavity, wherein the sealed pocket contains at least one of the group comprising squeakers, noise makers, aromatic objects, catnip, cedar chips, auditory objects, and tactile objects.

42. A method for manufacturing a stuffed article, comprising the steps of:
folding a single continuous piece of material into a desired shape; and
binding together at least a portion of a perimeter of the folded single continuous piece of material thereby creating the stuffed article with an outer cover and an inner stuffing, wherein the outer cover of the stuffed article is formed from a first section of the single continuous piece of material and the inner stuffing is formed from a second section of the single continuous piece of material.

43. The method for manufacturing a stuffed article according to claim 42, wherein the binding comprises at least one of the group comprising thread, glue, heat welding, melting, zipper, hook and loop material, snaps, and spring clips.

44. The method for manufacturing a stuffed article according to claim 42, further comprising the step of:
inserting at least one of the group comprising squeakers, noise makers, aromatic objects, catnip, cedar chips, auditory objects, and tactile objects inside the stuffed article before the perimeter of the folded single continuous piece of material is bound.

45. The method for manufacturing a stuffed article according to claim 42, further comprising the step of:
attaching at least one of at least one tab, tabs, fringe, string, at least one handle and rope so as to protrude from the outer cover of the stuffed article.

46. The method for manufacturing a stuffed article according to claim 42, wherein the stuffed article is at least one of the group comprising: an animal toy, flying disk, animal bed, children's toys, human bedding and pillows, and environmental products.

47. The method for manufacturing a stuffed article according to claim 42, wherein the material is from at least one of the group comprising: fabric, canvas, denim, fleece, nylon, rubber, plastic, leather, rawhide, animal parts, and fiber.

48. The method for manufacturing a stuffed article according to claim 42, wherein a shape of the stuffed article is determined by shape of the binding.

49. The method for manufacturing a stuffed article according to claim 42, further comprising the step of:
creating a sealed pocket formed by at least some of the material stuffed in the inner cavity, wherein the sealed pocket contains at least one of the group comprising squeakers, noise makers, aromatic objects, catnip, cedar chips, auditory objects, and tactile objects.
